(19) United States
(12) Patent Application Publication
(10) Pub. No.: US 2004/0142247 A1
(43) Pub. Date: Jul. 22, 2004

(54) Lithium secondary battery

(76) Inventors: Seiji Yoshimura, Kobe-city (JP); Naoki Imachi, Kobe-city (JP); Keiji Saishou, Kobe-city (JP); Masanobu Takeuchi, Kobe-city (JP)

Correspondence Address: KUBOVCIK & KUBOVCIK, SUITE 710, 900 17TH STREET NW, WASHINGTON, DC, 20006

(21) Appl. No.: 10/756,285

(22) Filed: Jan. 14, 2004

(30) Foreign Application Priority Data
Jan. 16, 2003 (JP) 2003-008032

(51) Int. Cl. H01M 10/40; H01M 4/40

(52) U.S. Cl. 429/333; 429/231.95

(57) ABSTRACT

A lithium secondary battery including a positive electrode, a negative electrode and a nonaqueous electrolyte containing a solute dissolved in a nonaqueous solvent, wherein a lithium-aluminum-manganese alloy in which lithium is occluded in an aluminum-manganese alloy is a material of the negative electrode, and the nonaqueous electrolyte contains a mixed solvent of a cyclic carbonate and a polyethylene glycol dialkyl ether as the nonaqueous solvent.

The present invention relates to a lithium secondary battery comprising a positive electrode, a negative electrode and a nonaqueous electrolyte comprising a solute dissolved in a nonaqueous solvent. Especially, the invention relates to improving storage characteristics of a lithium secondary battery by a suitable selection of a material for the negative electrode and of the nonaqueous solvent of the nonaqueous electrolyte.

### BACKGROUND OF THE INVENTION

A lithium secondary battery having high electromotive force that utilizes oxidation and reduction of lithium and a nonaqueous electrolyte comprising a solute dissolved in a nonaqueous solsolvent has recently been used as one of new type high output and high energy density batteries.

In such lithium secondary batteries, a carbon material capable of occluding and releasing lithium, lithium metal, or an alloy of lithium and a metal such as aluminum, lead, bismuth, tin, indium or the like, capable of occluding and releasing lithium is used as a material of the negative electrode.

When lithium metal is used for the negative electrode in a lithium secondary battery, there is a problem that dendrite is deposited during charging. Dendrite grows when charging and discharging are repeated and destroys a separator and the battery becomes incapable of being charged and discharged.

If an alloy of lithium and a metal capable of occluding and releasing lithium is used for the negative electrode, dendrite is not deposited because lithium is electrochemically occluded and released. The battery can be repeatedly charged and discharged.

However, there is a problem that the alloy increases and decreases in volume when lithium ions are occluded and released, and is gradually pulverized by repeated charge and discharge, and the battery is not able to obtain sufficient charge and discharge characteristics.

Therefore, a lithium-aluminum-manganese alloy in which lithium is occluded in an aluminum-manganese alloy has been recently proposed for use for a negative electrode of a lithium secondary battery to prevent pulverization of the alloy during repeated charge and discharge (Japanese Patent Laid-open Nos. 9-320634 and 2000-173627).

However, even if such a lithium-aluminum-manganese alloy is used as the negative electrode, if the lithium secondary battery is stored at a charge condition, the lithium-aluminum-manganese alloy reacts with the nonaqueous electrolyte to reduce storage characteristics.

### OBJECT OF THE INVENTION

An object of the present invention is to solve the above-described problems of a lithium secondary battery comprising a positive electrode, a negative electrode and a nonaqueous electrolyte in which a solute is dissolved in a nonaqueous solvent. That is, when a lithium secondary battery using, for the negative electrode, a lithium-aluminum-manganese alloy in which lithium is occluded in an aluminum-manganese alloy, is stored at a charge condition, an object is to prevent a reaction of the lithium-aluminum-manganese alloy and the nonaqueous electrolyte and to obtain excellent storage characteristics for the lithium secondary battery.

### SUMMARY OF THE INVENTION

The present invention relates to a lithium secondary battery comprising a positive electrode, a negative electrode and a nonaqueous electrolyte which includes a solute in a nonaqueous solvent, wherein the negative electrode comprises a lithium-aluminum-manganese alloy in which lithium is occluded in an aluminum-manganese alloy, and the nonaqueous electrolyte includes a mixed solvent of a cyclic carbonate and polyethylene glycol dialkyl ether as the nonaqueous solvent.

### BRIEF DESCRIPTION OF THE DRAWINGS

FIG. 1 is a cross section of the battery prepared in each of the Examples and Comparative Examples.

[Explanation of Elements]

1: positive electrode

2: negative electrode

3: separator

4: battery can

4a: positive electrode can

4b: negative electrode can

5: positive electrode current collector

6: negative electrode current collector

7: insulation packing

### DETAILED EXPLANATION OF THE INVENTION

In the lithium secondary battery of the present invention, the lithium-aluminum-manganese alloy reacts with the mixed solvent to form a fine film having excellent ion conductivity on a surface of the negative electrode. The film helps to prevent a reaction of the negative electrode and the nonaqueous electrolyte and to improve storage characteristics of the lithium secondary battery.

If the manganese content of the lithium-aluminum-manganese alloy is not suitable, i.e, too low or too high, the film formed on the negative electrode is not dense and does not have good ion conductivity, and it is difficult for a charge and discharge reaction to take place. Therefore, the manganese content in the alloy is preferably in a range of 0.1˜10 weight %.

A conventional cyclic carbonate can be used as the cyclic carbonate for the nonaqueous solvent. Especially, if at least one organic solvent selected from the group consisting of ethylene carbonate (EC), propylene carbonate (PC), butylene carbonate (BC) and vinylene carbonate (VC) is used as the nonaqueous solvent, a fine film having excellent ion conductivity can be formed on the negative electrode and the battery has further excellent storage characteristics.

As the polyethylene glycol dialkyl ether, diethylene glycol dialkyl ether, for example, diethylene glycol dimethyl ether, diethylene glycol diethyl ether, diethylene glycol di-n-propyl ether, diethylene glycol di-i-propyl ether, diethylene glycol di-n-butyl ether, and the like; triethylene glycol dialkyl ether, for example, triethylene glycol dimethyl ether, triethylene glycol diethyl ether, triethylene glycol di-n-propyl ether, and the like; tetraethylene glycol dialkyl ether, for example, teraethylene glycol dimethyl ether, tetraethylene glycol diethyl ether, tetraethylene glycol di-n-propyl ether, and the like; can be illustrated. Especially, if diethylene glycol dialkyl ether is used, a fine film having excellent ion conductivity can be formed and the battery has excellent storage characteristics.

If the amount of the cyclic carbonate in the nonaqueous solvent is too little, a sufficient film is not formed. On the other hand, if the amount of the cyclic carbonate in the nonaqueous solvent is too great, the formed film is too thick and charge and it is difficult for the discharge reaction to occur. Therefore, an amount of the cyclic carbonate in the nonaqueous solvent in a range of 0.1˜20 weight % is preferable.

As the solute dissolved in the nonaqueous electrolyte, a conventional solute can be used. Especially, if lithium bis(trifluoromethanesulfonyl)imide (LiN(CF₃SO₂)₂), lithium bis(pentafluoroethanesufonyl)imide (LiN(C₂F₅SO₂)₂), lithium tris(trifluoromethanesulfonyl)methide (LiC(CF₃SO₂)₃), lithium trifluoromethanesulfonate (LiCF₃SO₃), lithium hexafluorophosphate (LiPF₆) lithium tetrafluoroborate (LiBF₄), lithium hexafluoroarsenate (LiAsF₆), or lithium perchlorate (LiClO₄) is used, a fine film having excellent ion conductivity can be formed and the battery has excellent storage characteristics.

There is no limitation with respect to a positive electrode material. A known and conventional material for the positive electrode can be used. For example, manganese dioxide, vanadium pentoxide, niobium oxide, lithium cobalt oxide (LiCoO₂), lithium nickel oxide (LiNiO₂), lithium manganese oxide (LiMn₂O₄) having a spinel structure, lithium-manganese composite oxide including boron in which boron or a boron compound is dissolved as a solid solution, and the like can be illustrated. Especially, if LiMn₂O₄ having a spinel structure or a lithium-manganese composite oxide including boron is used, excellent storage characteristics and charge and discharge cycle characteristics can be obtained.

As the lithium-manganese composite oxide including boron, an atomic ratio of boron to manganese (B/Mn) is preferably in a range of 0.01˜0.20, and an average valence of manganese is preferably not less than 3.80.

To prepare a lithium-manganese composite oxide including boron, for example, a boron compound, a lithium compound and a manganese compound are mixed at an atomic ratio of boron, lithium and manganese (B:Li:Mn) of 0.01˜0.20:0.1˜2.0:1 and the mixture is treated by heating in air.

If a temperature of the heat treatment of the mixture is lower than 150° C., reaction is not sufficient and water contained in the manganese dioxide cannot be sufficiently removed. If a temperature of the heat treatment of the mixture is higher than 430° C., manganese dioxide is decomposed and the average valence of manganese is smaller than 3.80 and the balance of the electron condition of the lithium-manganese composite oxide including boron is lost and the composite oxide is easily dissolved into the nonaqueous electrolyte. Therefore, the temperature of heat treatment is preferably in a range of 150˜430° C., is more preferably in a range of 250˜430° C., and is further preferably in a range of 300˜430° C.

As the boron compound, for example, boron oxide (B₂O₃), boric acid (H₃BO₃), metaboric acid (HBO₂), lithium metaborate (LiBO₃) and lithium tetraborate (Li₂B₄O₇) can be illustrated. As the lithium compound, for example, lithium hydroxide (LiOH), lithium carbonate (Li₂CO₃), lithium oxide (Li₂O) and lithium nitrate (LiNO₃) can be illustrated. As the manganese compound, manganese oxide (MnO₂) and manganese oxyhydoxide (MnOOH) can be illustrated.

### DESCRIPTION OF PREFERRED EMBODIMENT

### EXAMPLES

Examples of a lithium secondary battery of the present invention are described below in detail with reference to the examples. A comparative example is also described below to make it clear that the lithium secondary battery in the examples has improved storage characteristics. It is of course understood that the present invention is not limited to the batteries of the following examples. The present invention can be modified within the scope and spirit of the appended claims.

### Example A1

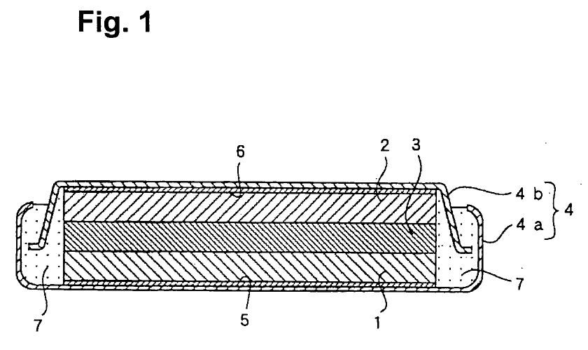

In Example A1, a flat (coin) shape lithium secondary battery having a diameter of 24 mm and a thickness of 3 mm as shown in FIG. 1 was prepared using a positive electrode, a negative electrode and a nonaqueous electrolyte prepared as described below.

[Preparation of Positive Electrode]

LiMn₂O₄ powder having a spinel structure was used as a positive electrode active material. The LiMn₂O₄ powder and carbon black powder as a conductive agent and a fluororesin powder as a binding agent were mixed in a ratio by weight of 85:10:5 to prepare a positive electrode mixture. The positive electrode mixture was fabricated into a disc by a foundry molding, and was dried at 250° C. for 2 hours under vacuum to prepare a positive electrode.

[Preparation of Negative Electrode]

Lithium film in an amount which provided a lithium concentration of 15 mol % relative to aluminum was put on an aluminum-manganese alloy plate (the manganese content based on the total weight of aluminum and manganese is 1 weight %), and the plate was dipped in a nonaqueous electrolyte prepared below to occlude lithium electrochemically in the aluminum-manganese alloy and to prepare a lithium-aluminum-manganese alloy (Li—Al—Mn). The lithium-aluminum-manganese alloy was punched out into a disc to prepare a negative electrode.

[Preparation of Nonaqueous Electrolyte]

Lithium trifluoromethanesulfonimide (LiN(CF₃SO₂)₂) as a solute was dissolved in, as a nonaqueous solvent, a mixture of propylene carbonate (PC), which is a cyclic carbonate, and diethylene glycol dimethyl ether (Di-DME) in a ratio of 1:99 by volume as shown in Table 1 to a concentration of 1 mol/l to prepare a nonaqueous electrolyte.

[Assembling of Battery]

The positive electrode 1 was mounted on a positive electrode current collector 5 comprising stainless steel (SUS316). The negative electrode 2 was mounted on a negative electrode current collector 6 comprising stainless steel (SUS304). A separator 3 comprising polyphenylene non-woven fabric was impregnated with the nonaqueous electrolyte. The separator was placed between the positive electrode 1 and negative electrode 2 and was placed in a battery case 4 comprising a positive electrode can 4a and a negative electrode can 4b. The positive electrode 1 was connected to the positive electrode can 4a through the positive electrode current collector 5. The negative electrode 2 was connected to the negative electrode can 4b through the negative electrode current collector 6. The positive electrode can 4a and negative electrode can 4b were electrically insulated by an insulation packing 7 to prepare a coin shape lithium secondary battery. An internal resistance of the battery before charge and discharge was 10 Ω.

### Example A2

A lithium secondary battery was prepared in the same manner as Example A1 except that a mixture of ethylene carbonate (EC) and Di-DME in a ratio of 1:99 by volume as shown in Table 1 was used as a nonaqueous solvent.

### Example A3

A lithium secondary battery was prepared in the same manner as Example A1 except that a mixture of butylene carbonate (BC) and Di-DME in a ratio of 1:99 by volume as shown in Table 1 was used as a nonaqueous solvent.

### Example A4

A lithium secondary battery was prepared in the same manner as Example A1 except that a mixture of vinylene carbonate (VC) and Di-DME in a ratio of 1:99 by volume as shown in Table 1 was used as a nonaqueous solvent.

### Example A5

A lithium secondary battery was prepared in the same manner as Example A1 except that a mixture of propylene carbonate (PC) and diethylene glycol diethyl ether (Di-DEE) in a ratio of 1:99 by volume as shown in Table 1 was used as a nonaqueous solvent.

### Example A6

A lithium secondary battery was prepared in the same manner as Example A1 except that a mixture of propylene carbonate (PC) and diethylene glycol dipropyl ether (Di-DPE) in a ratio of 1:99 by volume as shown in Table 1 was used as a nonaqueous solvent.

### Example A7

A lithium secondary battery was prepared in the same manner as Example A1 except that a mixture of propylene carbonate (PC) and triethylene glycol dimethyl ether (Tri-DME) in a ratio of 1:99 by volume as shown in Table 1 was used as a nonaqueous solvent.

### Example A8

A lithium secondary battery was prepared in the same manner as Example A1 except that a mixture of propylene carbonate (PC) and tetraethylene glycol dimethyl ether (Tetra-DME) in a ratio of 1:99 by volume as shown in Table 1 was used as a nonaqueous solvent.

### Comparative Example a1

A lithium secondary battery was prepared in the same manner as Example A1 except that a mixture of propylene carbonate (PC) and dimethoxy ethane (DME) in a ratio of 1:99 by volume as shown in Table 1 was used as a nonaqueous solvent.

### Comparative Example a2

A lithium secondary battery was prepared in the same manner as Example A1 except that a mixture of propylene carbonate (PC) and diethoxy ethane (DEE) in a ratio of 1:99 by volume as shown in Table 1 was used as a nonaqueous solvent.

### Comparative Example a3

A lithium secondary battery was prepared in the same manner as Example A1 except that a mixture of propylene carbonate (PC) and tetrahydrofuran (THF) in a ratio of 1:99 by volume as shown in Table 1 was used as a nonaqueous solvent.

### Comparative Example a4

A lithium secondary battery was prepared in the same manner as Example A1 except that a mixture of propylene carbonate (PC) and dioxolane (DOXL) in a ratio of 1:99 by volume as shown in Table 1 was used as a nonaqueous solvent.

### Comparative Example a5

A lithium secondary battery was prepared in the same manner as Example A1 except that a mixture of propylene carbonate (PC) and dimethyl carbonate (DMC) in a ratio of 1:99 by volume as shown in Table 1 was used as a nonaqueous solvent.

### Comparative Example a6

A lithium secondary battery was prepared in the same manner as Example A1 except that a mixture of propylene carbonate (PC) and diethyl carbonate (DEC) in a ratio of 1:99 by volume as shown in Table 1 was used as a nonaqueous solvent.

### Comparative Example a7

A lithium secondary battery was prepared in the same manner as Example A1 except that a mixture of propylene carbonate (PC) and N,N-dimethyl acetamide in a ratio of 1:99 by volume as shown in Table 1 was used as a nonaqueous solvent.

### Comparative Example a8

A lithium secondary battery was prepared in the same manner as Example A1 except that a mixture of propylene carbonate (PC) and thiophene in a ratio of 1:99 by volume as shown in Table 1 was used as a nonaqueous solvent.

### Comparative Example a9

A lithium secondary battery was prepared in the same manner as Example A1 except that a mixture of γ-butyrolactone (γ-BL) and diethylene glycol dimethyl ether (Di-DME) in a ratio of 1:99 by volume as shown in Table 1 was used as a nonaqueous solvent.

### Comparative Example a10

A lithium secondary battery was prepared in the same manner as Example A1 except that a mixture of γ-valerolactone (γ-VL) and diethylene glycol dimethyl ether (Di-DME) in a ratio of 1:99 by volume as shown in Table 1 was used as a nonaqueous solvent.

### Comparative Example a11

A lithium secondary battery was prepared in the same manner as Example A1 except that a mixture of sulfolane (SL) and diethylene glycol dimethyl ether (Di-DME) in a ratio of 1:99 by volume as shown in Table 1 was used as a nonaqueous solvent.

### Comparative Example a12

A lithium secondary battery was prepared in the same manner as Example A1 except that a mixture of 3-methylsulfolane (3-MeSL) and diethylene glycol dimethyl ether (Di-DME) in a ratio of 1:99 by volume as shown in Table 1 was used as a nonaqueous solvent.

### Comparative Example a13

A lithium secondary battery was prepared in the same manner as Example A1 except that diethylene glycol dimethyl ether (Di-DME) alone as shown in Table 1 was used as a nonaqueous solvent.

### Comparative Example a14

A lithium secondary battery was prepared in the same manner as Example A1 except that propylene carbonate (PC) alone as shown in Table 1 was used as a nonaqueous solvent.

Batteries of Examples A1˜A8 and Comparative Examples a1˜a14 were preheated at 180° C. for one minute, were passed through a reflow furnace in which the highest temperature was 260° C. and the lowest temperature of 180° C. was close to the entrance and exit of the furnace for one minute, and were discharged to 2 V at a current of 1 mA at 25° C. to measure discharge capacity (Qₒ).

Batteries of Examples A1˜A8 and Comparative Examples a1˜a14 were preheated at 180° C. for one minute, were passed through a reflow furnace in which the highest temperature was 260° C. and the lowest temperature of 180° C. was close to the entrance and exit of the furnace for one minute, were stored at 60° C. for two months, and then were discharged to 2 V at a current of 1 mA at 25° C. to measure discharge capacity (Qₐ).

Each battery's capacity maintenance rate (%) was calculated according to the expression below.

Capacity Maintenance Rate (%)=(Qₐ/Qₒ)×100

TABLE 1

| | | | Capacity |
|---|---|---|---|
| | Nonaqueous solvent and | | Maintenance |
| | ratio by volume | Solute | Rate (%) |
| Example A1 | PC:Di-DME = 1:99 | LiN(CF₃SO₂)₂ | 97 |
| Example A2 | EC:Di-DME = 1:99 | LiN(CF₃SO₂)₂ | 93 |
| Example A3 | BC:Di-DME = 1:99 | LiN(CF₃SO₂)₂ | 91 |
| Example A4 | VC:Di-DME = 1:99 | LiN(CF₃SO₂)₂ | 90 |
| Example A5 | PC:Di-DEE = 1:99 | LiN(CF₃SO₂)₂ | 92 |
| Example A6 | PC:Di-DPE = 1:99 | LiN(CF₃SO₂)₂ | 92 |
| Example A7 | PC:Tri-DME = 1:99 | LiN(CF₃SO₂)₂ | 89 |
| Example A8 | PC:Tetra-DME = 1:99 | LiN(CF₃SO₂)₂ | 84 |
| Comparative | PC:DME = 1:99 | LiN(CF₃SO₂)₂ | 52 |
| Example a1 | | | |
| Comparative | PC:DEE = 1:99 | LiN(CF₃SO₂)₂ | 53 |
| Example a2 | | | |
| Comparative | PC:THF = 1:99 | LiN(CF₃SO₂)₂ | 51 |
| Example a3 | | | |
| Comparative | PC:DOXL = 1:99 | LiN(CF₃SO₂)₂ | 51 |
| Example a4 | | | |
| Comparative | PC:DMC = 1:99 | LiN(CF₃SO₂)₂ | 50 |
| Example a5 | | | |
| Comparative | PC:DEC = 1:99 | LiN(CF₃SO₂)₂ | 46 |
| Example a6 | | | |
| Comparative | PC:N,N- | LIN (CF₃SO₂)₂ | 49 |
| Example a7 | dimethylacetamide = 1:99 | | |
| Comparative | PC:Thiophene = 1:99 | LiN(CF₃SO₂)₂ | 44 |
| Example a8 | | | |
| Comparative | γ-BL:Di-DME = 1:99 | LiN(CF₃SO₂)₂ | 45 |
| Example a9 | | | |
| Comparative | γ-VL:Di-DME = 1:99 | LiN(CF₃SO₂)₂ | 43 |
| Example a10 | | | |
| Comparative | SL:Di-DME = 1:99 | LiN(CF₃SO₂)₂ | 44 |
| Example a11 | | | |
| Comparative | 3-MeSL:Di-DME = 1:99 | LiN(CF₃SO₂)₂ | 41 |
| Comparative | Di-DME | LiN(CF₃SO₂)₂ | 55 |
| Example a13 | | | |
| Comparative | PC | LiN(CF₃SO₂)₂ | 58 |
| Example a14 | | | |

As is clear from the results, the lithium secondary batteries of Examples A1˜A8 have improved capacity maintenance rates and have excellent storage characteristics after the reflow treatment as compared to the batteries of Comparative Examples a1˜a14.

### Examples B1˜B4

Lithium secondary batteries were prepared in the same manner as Example A1 except that a lithium-aluminum manganese alloy having a manganese concentration in an aluminum-manganese alloy as shown in Table 2 were used to prepare a negative electrode.

Manganese concentration was 0.1 weight % in Example B1, 0.5 weight % in Example B2, 5 weight % in Example B3 and 10 weight % in Example B4.

### Comparative Example b1

A lithium secondary battery was prepared in the same manner as Example A1 except that graphite powder was used as a material for the negative electrode and a mixture of the graphite powder and fluororesin powder at a ratio of 95:5 by weight was fabricated into a disc as the negative electrode.

### Comparative Example b2

A lithium secondary battery was prepared in the same manner as Example A1 except that lithium metal was used as a material for the negative electrode, and was fabricated into a disc for the negative electrode.

### Comparative Example b3

A lithium secondary battery was prepared in the same manner as Example A1 except that a lithium-aluminum-chromium alloy in which the chromium concentration in the aluminum-chromium alloy was 1 weight % was used for a negative electrode as shown in Table 2.

### Comparative Example b4

A lithium secondary battery was prepared in the same manner as Example A1 except that a lithium-aluminum-vanadium alloy that vanadium concentration was 1 weight % in the aluminum-vanadium alloy was used for a negative electrode as shown in Table 2.

Capacity maintenance rate (%) of each battery of Example B1˜B4 and Comparative Example b1˜b4 was obtained in the same manner as Example A1. The results are shown in Table 2 together with the result of the battery of Example A1.

TABLE 2

| | | Capacity |
|---|---|---|
| | | Maintenance |
| | Negative Electrode | Rate (%) |
| Example B1 | Al—Mn (Mn: 0.1 weight %) | 91 |
| Example B2 | Al—Mn (Mn: 0.5 weight %) | 95 |
| Example A1 | Al—Mn (Mn: 1 weight %) | 97 |
| Example B3 | Al—Mn (Mn: 5 weight %) | 94 |
| Example B4 | Al—Mn (Mn: 10 weight %) | 92 |
| Comparative Example b1 | Graphite | 60 |
| Comparative Example b2 | Lithium metal | 62 |
| Comparative Example b3 | Al—Cr (Cr: 1 weight %) | 55 |
| Comparative Example b4 | Al—V (V: 1 weight %) | 53 |

As is clear from the results, when a mixture of a cyclic carbonate and polyethylene glycol dialkyl ether was used as the nonaqueous solvent for the nonaqueous electrolyte, the lithium secondary batteries of Examples B1˜B4 using a lithium-aluminum-manganese alloy in which the manganese concentration in the aluminum-manganese alloy is in a range of 0.1˜10 weight % have improved capacity maintenance rates and have excellent storage characteristics after the reflow treatment as compared to the batteries of Comparative Examples b1˜b4. Especially, the batteries of Examples A1, B2 and B3 in which the manganese concentrations are in a range of 0.5˜5 weight % had further improved storage characteristics.

### Examples C1˜C5

Lithium secondary batteries were prepared in the same manner as Example A1 except that a mixture of PC and Di-DME in different mixing ratios by volume as shown in Table 3 was used to prepare a nonaqueous electrolyte.

PC and Di-DME were mixed at a ratio of 0.1:99.9 by volume in Example C1, 0.5:99.5 in Example C2, 5:95 in Example C3, 10:90 in Example C4 and 20:80 in Example C5.

Capacity maintenance rate (%) of each battery of Examples C1˜C5 was obtained in the same manner as Example A1. The results are shown in Table 3 together with the results of the batteries of Example A1 and Comparative Examples a13 and a14.

TABLE 3

| | | Capacity |
|---|---|---|
| | Nonaqueous solvent and | Maintenance |
| | ratio by volume | Rate (%) |
| Comparative Example a13 | PC:Di-DME = 0:100 | 55 |
| Example C1 | PC:Di-DME = 0.1:99.9 | 90 |
| Example C2 | PC:Di-DME = 0.5:99.5 | 93 |
| Example A1 | PC:Di-DME = 1:99 | 97 |
| Example C3 | PC:Di-DME = 5:95 | 96 |
| Example C4 | PC:Di-DME = 10:90 | 91 |
| Example C5 | PC:Di-DME = 20:80 | 90 |
| Comparative Example a14 | PC:Di-DME = 100:0 | 58 |

As is clear from the results, when a lithium-aluminum-manganese alloy was used for the negative electrode, the batteries of Examples A1 and C1˜C5 in which the cyclic carbonate is contained in an amount of 0.1˜20 volume % in the mixed solvent of the nonaqueous electrolyte had significantly improved storage characteristics and excellent storage characteristics after reflow treatment as compared to the batteries of Comparative Examples a13 and a14 in which PC or Di-DME alone was used as the solvent for the nonaqueous electrolyte. Especially, when a nonaqueous electrolyte in which the cyclic carbonate is contained in a range of 0.5˜5 volume % was used (Examples A1, C2 and C4), storage characteristics were further improved.

### Examples D1˜D7

Lithium secondary batteries were prepared in the same manner as Example A1 except that the solute dissolved in a mixed solvent of PC and Di-DME at a ratio of 1:99 was changed as shown in Table 4.

As the solute, lithium bis (pentafluoroethanesufonyl) imide (LiN(C₂F₅SO₂)₂) in Example D1, lithium tris(trifluoromethanesulfonyl)methide (LiC(CF₃SO₂)₃) in Example D2, lithium trifluoromethanesulfonate (LiCF₃SO₃) in Example D3, lithium hexafluorophosphate (LiPF₆) in example D4, lithium tetrafluoroborate (LiBF₄) in example D5, lithium hexafluoroarsenate (LiAsF₆) in example D6, and lithium perchlorate (LiClO₄) in Example D7, were used.

Capacity maintenance rate (%) of each battery of Examples D1˜D7 was obtained in the same manner as Example A1. The results are shown in Table 4 together with the result for the battery of Example A1.

TABLE 4

| | | Capacity Maintenance |
|---|---|---|
| | Solute | Rate (%) |
| Example A1 | LiN(CF₃SO₂)₂ | 97 |
| Example D1 | LiN(C₂F₅SO₂)₂ | 93 |
| Example D2 | LiC(CF₃SO₂)₃ | 88 |
| Example D3 | LICF₃SO₃ | 90 |
| Example D4 | LiPF₆ | 77 |
| Example D5 | LiBF₄ | 80 |
| Example D6 | LiAsF₆ | 75 |
| Example D7 | LiClO₄ | 75 |

As is clear from the results, when a lithium-aluminum-manganese alloy was used for the negative electrode and the solute was dissolved in a mixed solvent of the cyclic carbonate and polyethylene glycol ether, the batteries of Examples A1 and D1˜D7 had improved capacity maintenance rates and excellent storage characteristics after reflow treatment as compared to the batteries of the Comparative Examples described above. When LiN(CF₃SO₂)₂, LiN(C₂F₅SO₂)₂ and LiCF₃SO₃ were used as the solutes (Examples A1, D1 and D3), storage characteristics were further improved.

### Examples E1˜E5

Lithium secondary batteries were prepared in the same manner as Example A1 except that a positive electrode active material as shown in Table 4 was used.

As the positive electrode active material, in Example E1, lithium hydroxide (LiOH), boron oxide (B₂O₃) and manganese dioxide (MnO₂) were mixed at an atomic ratio of 0.53:0.06:1.00 (Li:B:Mn), and were heated at 375° C. for 20 hours in air to obtain a lithium-manganese composite oxide containing boron.

In Example E2, LiOH and MnO₂ were mixed at an atomic ratio of 0.50:1.00 (Li:Mn), and were heated at 375° C. for 20 hours in air, and the obtained lithium-manganese composite oxide was used as the positive electrode active material.

Manganese dioxide (MnO₂), niobium oxide (Nb₂O₅) and vanadium oxide (V₂O₅) were used in Examples E3, E4 and E5, respectively.

Capacity maintenance rate (%) of each battery of Examples E1˜E5 was obtained in the same manner as Example A1. The results are shown in Table 5 together with the result for the battery of Example A1.

TABLE 5

| | | Capacity Maintenance |
|---|---|---|
| | Positive Electrode | Rate (%) |
| Example A1 | LiMn₂O₄ (spinel structure) | 97 |
| Example E1 | Lithium-manganese oxide | 95 |
| | containing boron | |
| Example E2 | Lithium-manganese oxide | 88 |
| Example E3 | MnO₂ | 80 |
| Example E4 | Nb₂O₅ | 75 |
| Example E5 | V₂O₅ | 77 |

As is clear from the results, when a lithium-aluminum-manganese alloy is used for the negative electrode and a mixed solvent of cyclic carbonate and polyethylene glycol dialkyl ether is used as a nonaqueous solvent, the batteries of Examples A1 and E1˜E5 prepared using the positive electrode active material shown in Table 5 had improved capacity maintenance rates and excellent storage characteristics as compared to the comparative batteries. Especially, the batteries prepared using lithium manganese oxide having a spinel structure (Example A1) and a lithium-manganese composite oxide containing boron (Example E1) had further improved storage characteristics.

### ADVANTAGES OF THE INVENTION

The present invention can improve storage characteristics of a lithium secondary battery because a fine film having excellent ion conductivity is formed on a surface of a negative electrode by a reaction of a mixed solvent comprising a cyclic carbonate and a polyethylene glycol dialkyl ether as a solvent for a nonaqueous electrolyte and a lithium-aluminum-manganese alloy used for the negative electrode, and the film prevents a reaction of the negative electrode and the nonaqueous electrolyte during storage at a condition of charging.

What is claimed is:

1. A lithium secondary battery comprising a positive electrode, a negative electrode and a nonaqueous electrolyte comprising a solute is dissolved in a nonaqueous solvent, wherein the negative electrode comprises a lithium-aluminum-manganese alloy in which lithium is occluded in a aluminum-manganese alloy, and the nonaqueous solvent comprises a mixed solvent of a cyclic carbonate and a polyethylene glycol dialkyl ether.

2. The lithium secondary battery according to claim 1, wherein the manganese concentration in the aluminum-manganese alloy is in a range of 0.1˜10 weight %.

3. The lithium secondary battery according to claim 1, wherein the polyethylene glycol dialkyl ether is diethylene glycol dialkyl ether.

4. The lithium secondary battery according to claim 2, wherein the polyethylene glycol dialkyl ether is diethylene glycol dialkyl ether.

5. The lithium secondary battery according to claim 1, wherein the cyclic carbonate is contained in the mixed solvent in a range of 0.1˜20 volume %.

6. The lithium secondary battery according to claim 2, wherein the cyclic carbonate is contained in the mixed solvent in a range of 0.1˜20 volume %.

7. The lithium secondary battery according to claim 3, wherein the cyclic carbonate is contained in the mixed solvent in a range of 0.1˜20 volume %.

8. The lithium secondary battery according to claim 4, wherein the cyclic carbonate is contained in the mixed solvent in a range of 0.1˜20 volume %.

9. The lithium secondary battery according to claim 1, wherein the solute is selected from the group consisting of lithium bis(trifluoromethanesulfonyl)imide (LiN(CF₃SO₂)₂), lithium bis(pentafluoroethanesufonyl)imide (LiN(C₂F₅SO₂)2) and lithium trifluoromethanesulfonate (LiCF₃SO₃).

10. The lithium secondary battery according to claim 2, wherein the solute is selected from the group consisting of lithium bis(trifluoromethanesulfonyl)imide (LiN(CF₃SO₂)₂), lithium bis(pentafluoroethanesufonyl)imide (LiN(C₂F₅SO₂)₂) and lithium trifluoromethanesulfonate (LiCF₃SO₃).

11. The lithium secondary battery according to claim 3, wherein the solute is selected from the group consisting of lithium bis(trifluoromethanesulfonyl)imide (LiN(CF₃SO₂)₂) lithium bis(pentafluoroethanesufonyl)imide (LiN(C₂F₅SO₂)₂) and lithium trifluoromethanesulfonate (LiCF₃SO₃).

12. The lithium secondary battery according to claim 4, wherein the solute is selected from the group consisting of lithium bis(trifluoromethanesulfonyl)imide (LiN(CF₃SO₂)₂), lithium bis(pentafluoroethanesufonyl)imide (LiN(C₂F₅SO₂)₂) and lithium trifluoromethanesulfonate (LiCF₃SO₃).

13. The lithium secondary battery according to claim 5, wherein the solute is selected from the group consisting of lithium bis(trifluoromethanesulfonyl)imide (LiN(CF₃SO₂)₂), lithium bis(pentafluoroethanesufonyl)imide (LiN(C₂F₅SO₂)₂) and lithium trifluoromethanesulfonate (LiCF₃SO₃).

14. The lithium secondary battery according to claim 6, wherein the solute is selected from the group consisting of lithium bis(trifluoromethanesulfonyl)imide (LiN(CF₃SO₂)₂), lithium bis(pentafluoroethanesufonyl)imide (LiN(C₂F₅SO₂)₂) and lithium trifluoromethanesulfonate (LiCF₃SO₃).

15. The lithium secondary battery according to claim 7, wherein the solute is selected from the group consisting of lithium bis(trifluoromethanesulfonyl)imide (LiN(CF₃SO₂)₂), lithium bis(pentafluoroethanesufonyl)imide (LiN(C₂F₅SO₂)₂) and lithium trifluoromethanesulfonate (LiCF₃SO₃).

16. The lithium secondary battery according to claim 8, wherein the solute is selected from the group consisting of lithium bis(trifluoromethanesulfonyl)imide (LiN(CF₃SO₂)₂), lithium bis(pentafluoroethanesufonyl)imide (LiN(C₂F₅SO₂)₂) and lithium trifluoromethanesulfonate (LiCF₃SO₃).
